(19) United States
(12) Patent Application Publication
(10) Pub. No.: US 2022/0032450 A1
(43) Pub. Date: Feb. 3, 2022

(54) MOBILE ROBOT, AND CONTROL METHOD OF MOBILE ROBOT

(71) Applicant: LG ELECTRONICS INC., Seoul (KR)

(72) Inventors: Junghwan KIM, Seoul (KR); Minho LEE, Seoul (KR); llsoo CHO, Seoul (KR)

(21) Appl. No.: 16/957,888

(22) PCT Filed: Dec. 11, 2018
(86) PCT No.: PCT/KR2018/015652

§ 371 Date: Oct. 18, 2021

(30) Foreign Application Priority Data
Dec. 11, 2017 (KR) 10-2017-0169710

(51) Int. Cl. B25J 9/16; G05B 13/02

(52) U.S. Cl. CPC B25J 9/163; B25J 5/007; G05B 13/0265

(57) ABSTRACT

Provided is a control method of a mobile robot, the method including an experience information generating step of obtaining current state information through sensing during traveling, and, based on a result of controlling an action according to action information selected by inputting the current state information to a predetermined action control algorithm for docking, generating one experience information that comprises the state information and the action information. The control method may further include an experience information collecting step of storing a plurality of experience information by repeatedly performing the experience information generating step, and a learning step of learning the action control algorithm based on the plurality of experience information.

### TECHNICAL FIELD

The present disclosure relates to machine learning of an action control algorithm of a mobile robot.

### BACKGROUND ART

In general, robots have been developed for industrial use and have been responsible for a part of factory automation. In recent years, the field of application of robots has been further expanded, medical robots, aerospace robots, etc. have been developed, and home robots that can be used in general homes are also being made. Among these robots, a mobile robot capable of driving by itself is called a mobile robot. A representative example of a mobile robot used at home is a robot cleaner.

Such a mobile robot is generally equipped with a rechargeable battery and is capable of driving itself with an obstacle sensor capable of avoiding obstacles while driving.

Recently, research has been actively conducted to utilize mobile robots in various fields such as health care, smart home, and remote control, rather than simply autonomous driving and cleaning.

In addition, the mobile robot can collect various information, and can process the collected information in various ways using a network.

In addition, docking devices such as charging stands for mobile robots to perform charging are known. The mobile robot performs a movement to return to the docking device when a task such as cleaning is completed while driving or an amount of charged power of the battery is less than or equal to a predetermined value.

In the prior art (Korean Patent Publication No. 10-2010-0136904) discloses an action algorithm by which a docking device (dock station) emits several types of docking induction signals in different ranges to differentiate surrounding areas and a robot cleaner detects the docking induction signals to performing docking.

### Patent Document

Korean Patent Application Publication No. 10-2010-0136904 (Publication date: Dec. 29, 2010)

### DISCLOSURE

### Technical Problem

In the related art, there is a problem that a docking device searching based on a docking induction signal causes a docking failure phenomenon frequently due to the existence of dead angle, and there is a problem that the number of docking attempts is increased until the docking succeeds or the required time for the docking success is prolonged. A first object of the present invention is to solve such a problem to increase efficiency of an action for docking of a mobile robot.

In the related art, there is a problem that the mobile robot can easily collide with an obstacle around the docking device. The second task of the present disclosure is to significantly increase the possibility of obstacle avoidance of the mobile robot.

An individual user environments may vary depending on a deviation of an environment in which the docking device is installed or a deviation of the docking device and the mobile robot. For example, each user environment may have a specific characteristic due to a deviation factor such as a slope, an obstacle, or a step in a place where the docking device is positioned. However, if an action of the mobile robot is controlled only with a action control algorithm pre-stored for all products in such a user environment having a specific characteristic, there is no room for improvement even if a docking failure occurs frequently. This is a very serious problem since a wrong action of the mobile robot constantly causes inconvenience to the user. A third task of the present disclosure is to solve this problem.

When the mobile robot is controlled only with a fixed action control algorithm as in the related art, the docking operation of the mobile robot cannot be adapted in response to a change in the user environment, such as a new type of obstacle appearing around the docking device. A fourth task of the present disclosure is to solve this problem.

A fifth task of the present disclosure is to efficiently collect data on an environment of the mobile robot for learning, and enabling efficient learning of an action control algorithm suitable for each environment using the collected data.

### Technical Solution

To solve the above problems, the present disclosure is not limited to an initially preset action control algorithm of a mobile robot, and proposes a solution for learning an action control algorithm by implementing a machine learning function.

In order to solve the above problems, there is provided a mobile robot including: a main body; a traveler configured to move the main body; a sensing unit configured to perform sensing during traveling to obtain current state information; and a controller configured to, based on a result of controlling an action according to action information selected by inputting the current state information to a predetermined action control algorithm for docking, generate one experience information including the state information and the action information, repeatedly perform the generating of the experience information to store a plurality of experience information, and learn the action control algorithm based on the plurality of experience information.

In order to solve the above problems, there is provided a control method of a mobile robot, including: an experience information generating step of obtaining current state information through sensing during traveling, and, based on a result of controlling an action according to action information selected by inputting the current state information to a predetermined action control algorithm for docking, generating one experience information comprising the state information and the action information. The control method may further include an experience information collecting step of storing a plurality of experience information by repeatedly performing the experience information generating step, and a learning step of learning the action control algorithm based on the plurality of experience information.

Each of the experience information may further include reward information that is set based on a result of controlling an action according to action information belonging to corresponding experience information.

The reward score may be set relatively high when docking succeeds as a result of performing the action according to the action information, and the reward score may be set relatively low when the docking fails when as a result of performing the action according to the action information.

The reward score may be set in relation to at least one of: i) whether docking succeeds as a result of performing the action according to the action information, ii) a time required for docking, iii) a number of docking attempts until docking succeeds, and iv) whether obstacle avoidance succeeds.

The action control algorithm may be set to select at least one of the following when one state information is input to the action control algorithm: i) exploitation action information to obtain a highest reward score among action information included in the experience information to which the one state information belongs, and ii) exploration action information other than action information included in the experience information to which the one state information belongs.

The action control algorithm may be preset before the learning step and may be able to be changed through the learning step.

The state information may include relative position information of the docking device and the mobile robot.

The state information may include image information on at least one of the docking device and an environment around the docking device.

The mobile robot may be configured to transmit the experience information to a server over a predetermined network. The server may be configured to perform the learning step.

In order to solve the above problems, there is provided a control method of a mobile robot, the method including an experience information generating step of obtaining nth state information through sensing in a state at an nth point in time during traveling, and, based on a result of controlling an action according to nth action information selected by inputting the nth state information to a predetermined action control algorithm for docking, generating nth experience information comprising the nth state information and the nth action information. The control method may include an experience information collecting step of storing first to pth experience information by repeatedly performing the experience information generating step in ab order from a case where n is 1 to a case where n is p, and a learning step of learning the action control algorithm based on the first to pth experience information. Here, p may be a natural number equal to or greater than 2, and a state at a p+1th point in time may be a docking complete state.

The n-th experience information may further include an n+1th reward score that is set based on a result of controlling an action according to the nth action information.

In the experience information generating step, the n+1th reward score may be set in response to n+1th state information obtained through sensing in a state at a n+1th point in time.

The n+1th reward score may be set relatively high when the state at the n+1th point in time is a docking complete state, and the n+1th reward score is set relatively low when the state at the n+1th point in time is a docking incomplete state.

Based on a plurality of pre-stored experience information to which the n+1th state information belongs, the n+1th reward score may be set to increase i) as a probability of a docking success after the n+1th state increases, ii) as a probabilistically expected time required until docking succeeds after the n+1th state decreases, or iii) as a probabilistically expected number of docking attempts until docking succeeds after the n+1th state decrease.

The n+1th reward score may be set, based on a plurality of pre-stored experience information to which the n+1th state information belongs, to increase as a probability of a collision with an external obstacle after the n+1th state decreases.

In order to solve the above problems, there is provided a control method of a mobile robot, the method including: an experience information generating step of obtaining nth state information through sensing in a state at an nth point in time during traveling, based on a result of controlling an action according to nth action information selected by inputting the nth state information to a predetermined action control algorithm for docking, obtaining n+1th reward score, and generating nth experience information comprising the nth state information, the nth action information, and the n+1th reward score. The control method may include an experience information collecting step of storing first to pth experience information by repeatedly performing the experience information generating step in ab order from a case where n is 1 to a case where n is p, and a learning step of learning the action control algorithm based on the first to pth experience information. Here, p may be a natural number equal to or greater than 2, and a state at a p+1th point in time may be a docking complete state.

### Advantageous Effects

Through the above solution, there is an effect that the mobile robot can efficiently perform an action for docking and perform an action of efficiently avoiding an obstacle.

Through the above solution, there is an effect to increase a success rate of docking of the mobile robot, reduce the number of docking attempts until docking succeeds, or reduce a time required until docking succeeds.

As the mobile robot generates a plurality of experience information and learns an action control algorithm based on the plurality of experience information, it is possible to implement an action control algorithm optimized for a user environment. In addition, it is possible to implement an action control algorithm that effectively responds to and adapts to a change in the user environment.

Each of the experience information may further include the reward score to perform reinforcement learning. In addition, by associating the reward score with docking or obstacle avoidance, it is possible to efficiently control an action of the mobile robot.

As the action control algorithm is set to select any one of the exploitation action information and the exploration action information, it is possible to generate a more variety of experience information and enable an optimized action to be performed. Specifically, in an early stage where learning has been proceeded relatively less since a relatively less amount of experience information has been stored, it is possible to select a more variety of the exploration action information in one state and generate more diverse experience information. In addition, after a sufficient number of experience information is sufficiently accumulated over a predetermined level and sufficiently learned, the action control algorithm may select the exploitation action information with a very high probability in one state. Therefore, as more and more experience information is accumulated over time, the mobile robot may be more successfully docked or avoid an obstacle by performing an optimal action.

The action control algorithm is preset before the learning step, so that docking performance of a certain level or above can be achieved even when a user first uses the mobile robot.

Since the state information includes the relative location information, it is possible to receive a more precise feedback as a result of performing an action according to the action information.

By performing the learning step, the server may perform more effective learning through server-based learning, while learning the action control algorithm based on information on an environment where the mobile robot is located. In addition, there is an effect of reducing the burden of a memory (storage) of the mobile robot. In addition, in machine learning, the fact that one of the experience information generated by one mobile robot can be used for learning an action control algorithm of another mobile robot means that the learning can be commonly performed through a server. Accordingly, it is possible to reduce the amount of efforts to be made by each of a plurality of mobile robots to generate separate experience information individually.

### DESCRIPTION OF DRAWINGS

FIG. 1 is a perspective view illustrating a mobile robot 100 and a docking device 200 which the mobile robot is docked according to an embodiment of the present disclosure.

FIG. 2 is an elevational view of the mobile robot 100 of FIG. 1 as viewed from above.

FIG. 3 is an elevational view of the mobile robot 100 of FIG. 1 as viewed from the front.

FIG. 4 is an elevational view of the mobile robot 100 of FIG. 1 as viewed from below.

FIG. 5 is a block diagram illustrating a control relationship between main components of the mobile robot 100 of FIG. 1.

FIG. 6 is a conceptual diagram illustrating a network between the mobile robot 100 and the server 500 of FIG. 1.

FIG. 7 is a conceptual diagram illustrating an example of the network of FIG. 6.

FIG. 8 is a flowchart illustrating a control method of the mobile robot 100 according to an embodiment.

FIG. 9 is a flowchart illustrating a detailed example of the control method of FIG. 8.

FIG. 10 is a flowchart illustrating a process of learning based on collected experience information according to an embodiment.

FIG. 11 is a flowchart illustrating a process of learning based on collected experience information according to another embodiment.

FIG. 12 is a conceptual diagram illustrating that a mobile robot is changed from a state corresponding to one state information to a state corresponding to another state information as a result of performing an action corresponding to one action information. FIG. 12 illustrates that each state information ST1, ST2, ST3, ST4, ST5, ST6, STf1, STs, . . . obtainable through sensing in respective states are shown as circles, and that action information A1, A2, A31, A32, A33, A34, A35, A4, A5, A6, A71, A72, A73, A74, A81, A82, A83, A84, . . . selectable in the respective states corresponding to the respective state information are shown as arrows, and that reward scores R1, R2, R3, R4, R5, R6, Rf1, Rs, . . . each obtained according to a state changed as a result of performing an action corresponding to any one action information are shown corresponding to the respective state information.

FIGS. 13 to 20 are plan views illustrating examples of states of the mobile robot 100 corresponding to the respective state information of FIG. 12 and selectable actions of the mobile robot 100 corresponding to the respective action information, the plan view which illustrates sensing an image as an example of obtaining state information.

FIG. 13 illustrates the state P(ST2) corresponding to the state information ST2 obtained through sensing as a result of performing the action P(A1) by the mobile robot 100 in the state P(ST1). In addition, FIG. 13 illustrates the state P(ST3) corresponding to the state information ST3 obtained through sensing of an image P3 as a result of performing the action P(A2) by the mobile robot 100 in the state P(ST2). In addition, FIG. 13 illustrates examples of the several actions P(A31), P(A32), and P(A33) that are selectable in the current state P(ST3) of the mobile robot 100.

FIG. 14 is a view illustrating the state P(ST4) corresponding to the state information ST4 obtained through sensing as a result of performing the action P(A32) by the mobile robot 100 in the state P(ST3), the view which shows an example of the action P(A4) selectable in the current state P(ST4) of the mobile robot 100.

FIG. 15 is a view illustrating the state P(ST5) corresponding to the state information ST5 obtained through sensing as a result of performing the action P(A33) performed by the mobile robot 100 in the state P(ST3), the view which shows an example of the action P(A5) selectable in the current state P(ST5) of the mobile robot 100.

FIG. 16 is a view illustrating the state P(ST6) corresponding to the state information ST6 obtained through sensing as a result of performing the action P(A5) performed by the mobile robot 100 in the state P(ST5), the view which shows an example of the action P(A6) selectable in the current state P(ST6) of the mobile robot 100.

FIG. 17 is a view illustrating the state P(ST7) corresponding to the state information ST7 obtained through sensing an image P7 as a result of performing the action P(A31) performed by the mobile robot 100 in the state P(ST3), the view which shows examples of the actions P(A71), P(A72), P(A73) selectable in the current state P(ST4) of the mobile robot 100.

FIG. 18 is a view illustrating a docking failure state P(STf1) corresponding to the state information STf1 obtained through sensing as a result of performing the action P(A71) performed by the mobile robot 100 in the state P(ST4), the view which shows examples of the actions P(A81), P(A82), P(A83) selectable in the current state P(STf1) of the mobile robot 100.

FIG. 19 is a view illustrating a different docking failure state P(STf2) corresponding to state information STf2 obtained through sensing, the view which shows examples of actions P(A91), P(A92), P(A93) selectable in the current state P(STf2) of the mobile robot 100.

FIG. 20 is a view illustrating a docking success state P(STs) corresponding to state information STs obtained through sensing. For example, the docking success state P(STs) is reached as a result of performing the action P(A4) by the mobile robot 100 of FIG. 14 in the state P(ST4), and the docking success state P(STs) is reached as a result of performing the action P(A6) by the mobile robot of FIG. 16 in the state P(ST6).

### MODE FOR INVENTION

Mobile robots 100 according to the present disclosure mean robots capable of moving by using a wheel or the like, and may be domestic robots and robot cleaners.

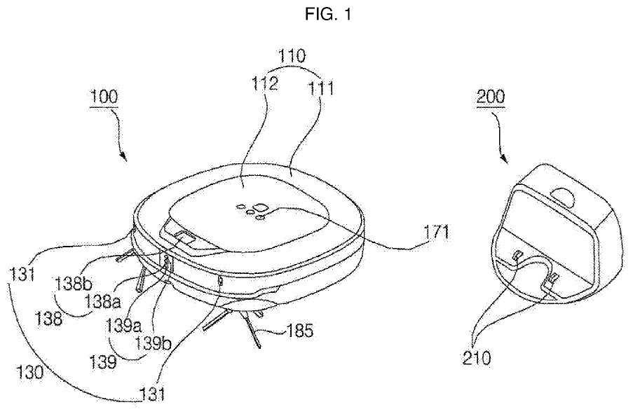

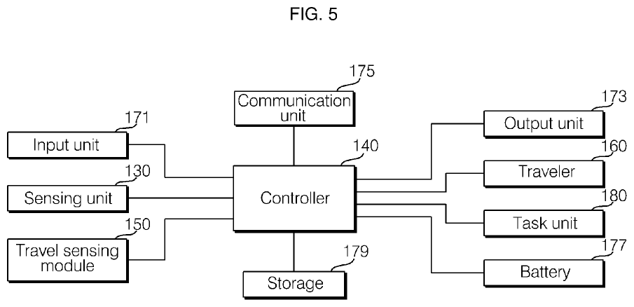

Hereinafter, referring to FIGS. 1 to 5, a robot cleaner 100 among the mobile robots will be described as an example, but is not necessarily limited thereto.

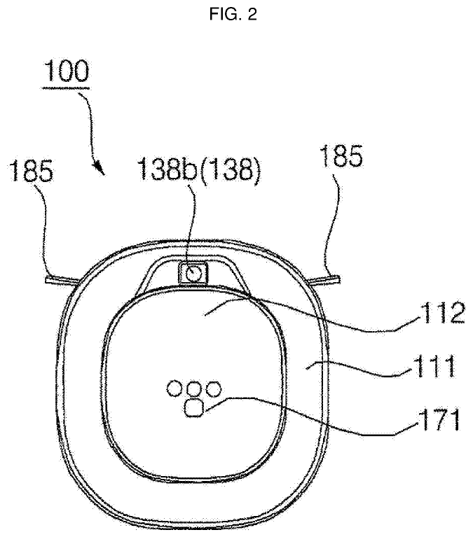

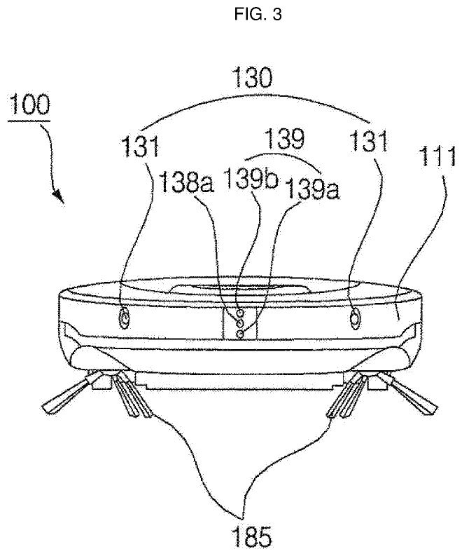

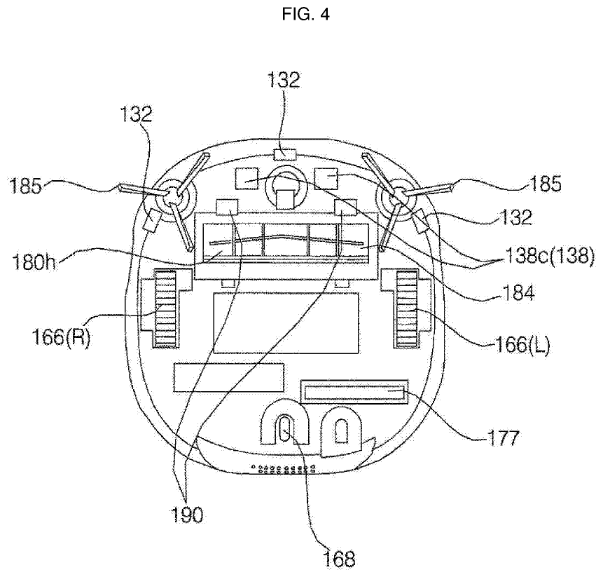

The mobile robot 100 includes a main body 110. Hereinafter, as to defining each part of the main body 110, a portion facing a ceiling in a travel area is defined as an top part (see FIG. 2), a portion facing a floor in the travel area is defined as a bottom part (see FIG. 4), and a portion facing a direction of travel in the circumference of the main body 110 between the top part and the bottom part is defined as a front part (see FIG. 3). In addition, a portion facing the opposite direction to the front part of the main body 110 may be defined as a rear part.

The main body 110 may include a case 111 defining a space to accommodate various components of the moving robot 100. The mobile robot 100 includes a sensing unit 130 that performs sensing to obtain current state information. The mobile robot 100 includes a traveler 160 that moves the main body 110. The mobile robot 100 includes a task unit 180 that performs a predetermined task while traveling. The mobile robot 100 includes a controller 140 for controlling the mobile robot 100.

The sensing unit 130 may perform sensing while traveling. State information is generated by the sensing unit 130. The sensing unit 130 may sense a situation around the mobile robot 100. The sensing unit 130 may sense a state of the mobile robot 100.

The sensing unit 130 may sense information about a travel area. The sensing unit 130 may sense obstacles such as walls, furniture, and cliffs on the driving surface. The sensing unit 130 may sense the docking device 200. The sensing unit 130 may sense information on a ceiling. Through the information sensed by the sensing unit 130, the mobile robot 100 may map the travel area.

The state information refers to information obtained through sensing by the mobile robot 100. The state information may be obtained immediately by sensing of the sensing unit 130 or may be obtained by being processed by the controller 140. For example, distance information may be obtained directly through an ultrasonic sensor, or the controller may convert information sensed through the ultrasonic sensor to obtain the distance information.

The state information may include information about a situation around the mobile robot 100. The state information may include information about a state of the mobile robot 100. The state information may include information about the docking device 200.

The sensing unit 130 may include a distance sensor 131, a cliff sensor 132, an external signal sensor (not shown), an impact sensor (not shown), an image sensor 138, and a 3D sensor 138a, 139a, 139b, and a docking sensor.

The sensing unit 130 may include a distance sensor 131 that senses a distance to surrounding objects. The distance sensor 131 may be disposed at the front part of the body 110 or may be disposed a lateral part. The distance sensor 131 may sense a nearby obstacle. A plurality of distance sensors 131 may be provided.

For example, the distance sensor 131 may be an infrared sensor, an ultrasonic sensor, an RF sensor, a geomagnetic sensor, and the like which has a light emitting unit and a light receiving unit. The distance sensor 131 may be implemented using ultrasonic waves or infrared rays. The distance sensor 131 may be implemented using a camera. The distance sensor 131 may be implemented as two or more types of sensor.

The state information may include information on a distance to a specific obstacle. The distance information may include information on a distance between the docking device 200 and the mobile robot 100. The distance information may include information on a distance between a specific obstacle around the docking device 200 and the mobile robot 100.

For example, the distance information may be obtained through sensing of the distance sensor 131. The mobile robot 100 may obtain information on a distance between the mobile robot 100 and the docking device 200 through reflection of infrared rays or ultrasonic waves.

As another example, the distance information may be measured as a distance between any two points on a map. The mobile robot 100 may recognize a location of the docking device 200 and a location of the mobile robot 100 on the map, and may obtain information on a distance between the docking device 200 and the mobile robot 100 using a difference in coordinates between the docking device 200 and the mobile robot 100 on the map.

The sensing unit 130 may include a cliff sensor 132 that senses an obstacle on the floor in the travel area. The cliff sensor 132 may sense the presence of a cliff on the floor.

The cliff sensor 132 may be disposed on the bottom part of the mobile robot 100. A plurality of cliff sensors 132 may be provided. A cliff sensor 132 disposed at a front side of the bottom part of the mobile robot 100 may be provided. A cliff sensor 132 disposed at a rear side of the bottom part of the mobile robot 100 may be provided.

The cliff sensor 132 may be an infrared sensor equipped with a light emitting unit and a light receiving unit, an ultrasonic sensor, an RF sensor, a Position Sensitive Detector (PSD) sensor, or the like. For example, the cliff sensor may be a PSD sensor and may also be composed of a plurality of different sensors. The PSD sensor includes a light emitting unit for emitting infrared rays to an obstacle, and a light receiving unit for receiving infrared rays reflected and returned from an obstacle.

The cliff sensor 132 may sense the presence of a cliff and a depth of the cliff and accordingly may obtain state information about a positional relationship between the mobile robot 100 and the cliff.

The sensing unit 130 may include the impact sensor that senses an impact on the mobile robot 100 due to contact with an external object.

The sensing unit 130 may include the external signal sensor that senses a signal sent from the outside of the mobile robot 100. The external signal sensor may include at least one of: an infrared ray sensor for sensing an infrared signal from the outside, an ultrasonic sensor for sensing an ultrasonic signal from the outside, and a radio frequency (RF) sensor for detecting an RF signal from the outside.

The mobile robot 100 may receive a guide signal generated by the docking device 200 using an external signal sensor. The external signal sensor may sense a guide signal (for example, an infrared signal, an ultrasonic signal, and an RF signal) of the docking device 200 to generate state information about relative positions of the mobile robot 100 and the docking device 200. The state information about the relative positions of the mobile robot 100 and the docking device 200 may include information on a distance and a direction of the docking device 200 with respect to the mobile robot 100. The docking device 200 may transmit a guide signal indicating the direction and distance of the docking device 200. The mobile robot 100 may obtain state information about a current position by receiving a signal transmitted from the docking device 200, and may select action information to move in order to attempt docking with the docking device 200.

The sensing unit 130 may include an image sensor 138 that senses an image of the outside of the mobile robot 100.

The image sensor 138 may include a digital camera. The digital camera may include at least one optical lens, an image sensor (e.g., a CMOS image sensor) including a plurality of photodiodes (e.g., pixels) on which an image is created by light transmitted through the optical lens, and a digital signal processor (DSP) to construct an image based on signals output from the photodiodes The DSP may produce not only a still image, but also a video consisting of frames constituting still images.

The image sensor 138 may include a front image sensor 138a that senses an image of an area forward of the mobile robot 100. The front image sensor 138a may sense an image of a nearby object such as an obstacle or the docking device 200.

The image sensor 138 may include an upper image sensor 138b that senses an image of an area upward of the mobile robot 100. The upper image sensor 138b may sense an image of a ceiling or a lower side of furniture disposed above the mobile robot 100.

The image sensor 138 may include a lower image sensor 138c that senses an image of an area downward of the mobile robot 100. The lower image sensor 138c may sense an image of a floor.

In addition, the image sensor 138 may include a sensor that senses an image of an area on a side of or rearward of the mobile robot.

The state information may include image information obtained by the image sensor 138.

The sensing unit 130 may include a 3D sensor 138a, 139a, and 139b that senses 3D information of an external environment.

The 3D sensor 138a, 139a, and 139b may include a 3D depth camera 138a that calculates a perspective distance between the mobile robot 100 and an object to be photographed.

In this embodiment, the 3D sensors 138a, 139a, and 139b include a pattern emission unit 139 for emitting light in a predetermined pattern forward from the main body 110, and a front image sensor 138a for obtaining an image of an area forward from the main body 110. The pattern emission unit 139 may include a first pattern emission unit 139a for emitting light in a first pattern downward and forward from the main body 110, and a second pattern emission unit 139b for emitting light in a second pattern upward and forward from the body 110. The front image sensor 138a may obtain an image of an area onto which the light in the first pattern and the light in the second pattern are incident.

The pattern emission unit 139 may be provided to emit an infrared pattern. In this case, the front image sensor 138a may measure a distance between the 3D sensor and the object to be photographed, by capturing a shape in which the infrared pattern is projected on the object to be photographed.

The light in the first pattern and the light in the second pattern may be emitted in the shape of straight lines crossing each other. The light in the first pattern and the light in the second pattern may be emitted in the shape of lines extending in a horizontal direction while vertically spaced apart from each other.

The second laser may emit a single straight-line laser. Accordingly, a lowermost laser is used to sense an obstacle on a floor, an uppermost laser is used to sense an obstacle above the floor, and an intermediate laser between the lowermost laser and the uppermost laser is used to sense an obstacle in the middle between the lowermost laser and the uppermost laser.

Although not illustrated, in another embodiment, the 3D sensor may be formed in a stereoscopic vision manner by including two or more cameras that obtain a conventional 2D image, and combine two or more images obtained from the two or more cameras to generate 3D coordinate information.

Although not illustrated, in another embodiment, the 3D sensor may include a light emitting unit for emitting a laser and a light receiving unit for receiving part of a laser emitted from the light emitting unit and reflected from an object to be photographed. In this case, a distance between the 3D sensor and the object to be photographed may be measured by analyzing the received laser. The 3D sensor may be implemented in a time of flight (TOF) method.

The sensing unit 130 may include a docking sensor (not shown) that senses whether docking with the docking device 200 of the mobile robot 100 is successful. The docking sensor may be implemented to sense the docking on the basis of contact between a corresponding terminal 190 and a charging terminal 210, or may be implemented as a detection sensor disposed separately from the corresponding terminal 190, and may be implemented to sense the docking by sensing a state of charge of a battery 177 while being charged. A docking success state and a docking failure state may be sensed by the docking sensor.

The traveler 160 moves the main body 110 with respect to the floor. The traveler 160 may include at least one driving wheel 166 that moves the main body 110. The traveler 160 may include a driving motor. The driving wheel 166 may include a left wheel 166(L) and a right wheel 166(R) that are provided on the left and right sides of the main body 110, respectively.

The left wheel 166(L) and the right wheel 166(R) may be driven by a single motor, but, when necessary, a left wheel motor for driving the left wheel 136(L) and a right wheel motor for driving the right wheel 136(R) may be provided individually A direction of travel of the main body 110 may be changed to the left or to the right by differentiating a speed of rotation of the left wheel 136(L) and the right wheel 136(R)

The traveler 160 may include an auxiliary wheel 168 that does not provide an additional driving force but supports the main body against the floor.

The mobile robot 100 may include a travel sensing module 150 that senses an action of the mobile robot 100. The travel sensing module 150 may sense an action of the mobile robot 100 by the traveler 160.

The travel sensing module 150 may include an encoder (not shown) that senses a traveling distance of the mobile robot 100. The travel sensing module 150 may include an acceleration sensor (not shown) that senses an acceleration of the mobile robot 100. The travel sensing module 150 may include a gyro sensor (not shown) that senses the rotation of the mobile robot 100.

Through sensing by the travel sensing module 150, the controller 140 may obtain information on a traveling path of the mobile robot 100. For example, based on a rotational speed of the drive wheel 166 sensed by the encoder, information on a current or past speed, a distance traveled, and the like of the mobile robot 100 may be obtained. For example, information on a current or past direction change process may be obtained according to a rotational direction of each driving wheel 166(L) or 166(R).

For example, when controlling an action of the mobile robot 100 according to an action control algorithm, the controller 140 may precisely control the action of the mobile robot 100 based on a feedback from the travel sensing module 150.

As another example, when controlling an action of the mobile robot 100 according to an action control algorithm, the controller 140 may precisely control the action of the mobile robot 100 by identifying a position of the mobile robot 100 on a map.

The mobile robot 100 includes a tak unit 180 that performs a predetermined task.

As an example, the task unit 180 may be provided to perform domestic work such as cleaning (sweeping, vacuuming, wet mopping, etc.), washing dishes, cooking, laundry, and garbage removal. As another example, the task unit 180 may be provided to perform a task such as manufacturing or repairing an apparatus. As another example, the task unit 180 may perform a task such as finding an object or repelling an insect. In the present embodiment, the task unit 180 is described as performing a cleaning task, but the task unit 180 may perform various tasks that are not necessarily limited to the examples of the above description.

The mobile robot 100 may move a travel area and clean the floor by the task unit 180. The task unit 180 may include a suction device for suctioning foreign substances, a brush 184 and 185 for brushing foreign substances, a dust container (not shown) for storing foreign substances collected by the suction device or the brush, and/or a mop for wet mopping.

A suction port 180h to suction air may be formed on the bottom part of the main body 110. The main body 110 may be provided with a suction device (not shown) to provide suction force to cause air to be suctioned through the suction port 180h, and a dust container (not shown) to collect dust suctioned together with air through the suction port 180h.

An opening allowing insertion and retrieval of the dust container therethrough may be formed on the case 111, and a dust container cover 112 to open and close the opening may be provided rotatably relative to the case 111.

The task unit 180 may include a roll-type main brush having bristles exposed through the suction port 110h, and an auxiliary brush 185 positioned at the front side of the bottom part of the main body 110 and having bristles forming a plurality of radially extending blades. Dust is separated from the floor in a travel area by rotation of the brushes 184 and 185, and such dust separated from the floor in this way is suctioned through the suction port 180h and collected in the dust container.

When docked with the docking device 200, the mobile robot 100 includes the corresponding terminal 190 for charging the battery 177. In a docking success state of the mobile robot 100, the corresponding terminal 190 is disposed at a position where it is possible to access the charging terminal 210 of the docking device 200. In this embodiment, a pair of corresponding terminals 190 are disposed at the bottom part of the main body 110.

The mobile robot 100 may include an input unit 171 for inputting information. The input unit 171 may receive an On/Off command or any other various commands. The input unit 171 may include a button, a key, a touch-type display, or the like. The input unit 171 may include a microphone for speech recognition.

The mobile robot 100 may include an output unit 173 for outputting information. The output unit 173 may inform a user of various types of information. The output unit 173 may include a speaker and/or a display.

The mobile robot 100 may include a communication unit 175 that transmits and receives information to and from other external devices. The communication unit 175 may be connected to a terminal device and/or a different device positioned within a specific area via one of wired, wireless, and satellite communication schemes so as to transmit and receive data

The communication unit 175 may be provided to communicate with other devices, such as a terminal 300a, a wireless router 400 and/or a server 500. The communication unit 175 may communicate with other devices within a specific area. The communication unit 175 may communicate with the wireless router 400. The communication unit 175 may communicate with the mobile terminal 300a. The communication unit 175 may communicate with the server 500.

The communication unit 175 may receive various command signals from an external device such as the terminal 300a. The communication unit 175 may transmit information to be output to an external device such as the terminal 300a. The terminal 300a may output information received from the communication unit 175.

Referring to Ta of FIG. 7, the communication unit 175 may wirelessly communicate with the wireless router 400. Referring to Tc of FIG. 7, the communication unit 175 may wirelessly communicate with the mobile terminal 300a. Although not illustrated, the communication unit 175 may wirelessly communicate directly with the server 500. For example, the communication unit 175 may wirelessly communicate using a wireless communication technology such as IEEE 802.11 WLAN, IEEE 802.15 WPAN, UWB, Wi-Fi, Zigbee, Z-wave, Blue-Tooth, and the like. The communication unit 175 may vary depending on a type of the different device to communicate or a communication scheme of the server.

State information obtained through the sensing of the sensing unit 130 may be transmitted through the communication unit 175 to a network. Through the communication unit 175, experience information to be described later may be transmitted to the network.

Information may be received by the mobile robot 100 on the network through the communication unit 175, and the mobile robot 100 may be controlled based on the received information. Based on information (e.g., update information) received from the mobile robot 100 on the network through the communication unit 175, the mobile robot 100 may update an algorithm for control traveling (e.g., an action control algorithm).

The mobile robot 100 includes the battery 177 for supplying driving power to respective components. The battery 177 supplies power for the mobile robot 100 to perform an action according to selected action information. The battery 177 is mounted to the main body 110. The battery 177 may be detachably provided in the main body 110.

The battery 177 is provided to be rechargeable. When the mobile robot 100 is docked with the docking device 200, the battery 177 may be charged through connection between the charging terminal 210 and the corresponding terminal 190. When the amount of charged power of the battery 177 becomes equal to or less than a predetermined value, the mobile robot 100 may start a docking mode for charging. In the docking mode, the mobile robot 100 may return to the docking device 200, and, the mobile robot 100 may sense the position of the docking device 200 during the return trip of the mobile robot 100.

Referring back to FIGS. 1 to 5, the mobile robot 100 includes a storage 179 that stores various information. The storage 179 may include a volatile or nonvolatile recording medium.

State information and action information may be stored in the storage 179. The storage 179 may store correction information to be described later. The storage 179 may store experience information to be described later.

The storage 179 may store a map of a travel area. The map may be a map input by an external terminal capable of exchanging information with the mobile robot 100 through the communication unit 175, or may be a map generated by the mobile robot 100 through self-learning. In the former case, examples of the external terminal 300a may include a remote controller equipped with an application for map setting, a personal digital assistant (PDA), a laptop, a smart phone, and a tablet.

The mobile robot 100 includes the controller 140 that processes and determines various types of information such as mapping and/or recognizing a current position. The controller 140 may control the overall operations of the mobile robot 100 by controlling various components of the mobile robot 100. The controller 140 may be configured to map the travel area through the image and recognize the current position on the map. That is, the controller 140 may perform a Simultaneous Localization and Mapping (SLAM) function.

The controller 140 may receive information from the input unit 171 and process the received information. The controller 140 may receive information from the communication unit 175 and process the received information. The controller 140 may receive information from the sensing unit 130 and process the received information.

The controller 140 may control an action using a predetermined action control algorithm based on obtained state information. Here, ‘obtaining state information’ refers to a concept that includes generating new state information not matching any of pre-stored state information, and selecting matching state information from the pre-stored state information.

Here, when current state information STp is the same as pre-stored state information STq, the current state information STp matches the pre-stored state information STq. In addition, until the current state information STp has a predetermined similarity or higher with the previously stored state information STq, it may be set that the current state information STp matches the previously stored state information STq.

Such a determination may be made based on the predetermined similarity. For example, when current state information obtained through sensing of the sensing unit 130 has the predetermined similarity or higher with pre-stored state information, the pre-stored state information having the predetermined similarity or higher may be selected as the current state information.

The controller 140 may control the communication unit 175 to transmit information. The controller 140 may control outputting of the output unit 173. The controller 140 may control driving of the traveler 160. The controller 140 may control an operation of the task unit 180.

Meanwhile, the docking device 200 includes the charging terminal 210 provided to be connected to the corresponding terminal 190 in a docking success state of the mobile robot 100. The docking device 200 may include a signal transmitter (not shown) for transmitting the guide signal. The docking device 200 may be provided to be placed on a floor.

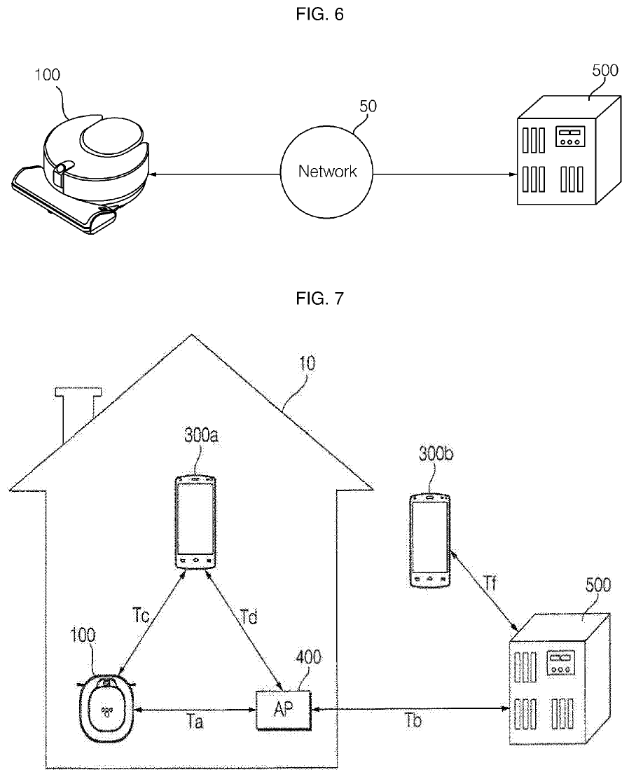

Referring to FIG. 6, the mobile robot 100 may communicate with the server 500 over a predetermined network. The communication unit 175 communicates with the server 500 over the predetermined network. The predetermined network refers to a communication network that is directly or indirectly connected via wired and/or wireless service. That is, the fact that “the communication unit 175 communicates with the server 500 over a specific network” includes not just the case where the communication unit 175 and the server 500 communicate directly with each other, but also the case where the communication unit 175 and the server 500 communicate indirectly with each other via the wireless router 400 or the like.

Such a network may be established based on technologies such as Wi-Fi, Ethernet, Zigbee, Z-Wave, Bluetooth, etc.

The communication unit 175 may transmit experience information, which is to be described later, to the server 500 over the predetermined network. The server 500 may transmit update information, which is to be described later, to the communication unit 175 over the predetermined network.

FIG. 7 is a conceptual diagram showing an example of the predetermined network. The mobile robot 100, the wireless router 400, the server 500, and mobile terminals 300a and 300b may be connected over the network to transmit and receive information with each other. Among them, the mobile robot 100, the wireless router 400, and the mobile terminal 300a may be positioned in a building 10 such as a house. The server 500 may be implemented inside the building 10, but may be a broad-range network that is implemented outside the building 10.

The wireless router 400 and the server 500 may include a communication module able to access the network according to a predetermined protocol. The communication unit 175 of the moving robot 100 is provided to access the network according to the predetermined protocol.

The mobile robot 100 may exchange data with the server 500 over the network. The communication unit 175 may exchange data with the wireless router 400 via wired or wireless communication, thereby exchanging data with the server 500. In this embodiment, the moving robot 100 and the server 500 communicate with each other through the wireless router 400 (see Ta and Tb in FIG. 7), but aspects of the present disclosure is not necessarily limited thereto.

Referring to Ta of FIG. 7, the wireless router 400 may be wirelessly connected to the mobile robot 100. Referring to Tb in FIG. 6, the wireless router 400 may be wired- or wireless-connected to the server 500. Through Td in FIG. 6, the wireless router 400 may be wireless-connected to the mobile terminal 200a.

Meanwhile, the wireless router 400 may allocate wireless channels to electronic devices located in a specific region according to a predetermined communication scheme, and perform wireless data communication using the wireless channels. Here, the predetermined communication scheme may be a Wi-Fi communication scheme.

The wireless router 400 may communicate with the moving robot 100 located within a predetermined range. The wireless router 400 may communicate with the mobile terminal 300a positioned within the predetermined range. The wireless router 400 may communicate with the server 500.

The server 500 may be accessible on the Internet. It is possible to communicate with the server 500 using any of various terminal devices 200b currently accessing the Internet. The terminal devices 200b may be a personal computer (PC), a smart phone, or the like.

Referring to Tb in FIG. 6, the server 500 may be wired- or wireless-connected to the wireless router 400. Referring to Tf in FIG. 7, the server 500 may be wireless-connected directly to the mobile terminal 300b. Although not illustrated in the drawings, the server 500 may communicate directly with the moving robot 100.

The server 500 includes a processor capable of processing a program. Functions of the server 500 may be performed by a central computer (Cloud) or by a user's computer or mobile terminal.

In one example, the server 500 may be a server administered by a manufacturer of the mobile terminal 100. In another example, the server 500 may be a server administered by an application store operator who is made public. In yet another example, the server 500 may be a home server that is provided at home, stores state information about home appliances at home, and contents shared between the home appliances.

The server 500 may store firmware information about the moving robot 100 and driving information (e.g., course information), and store product information of the moving robot 100.

In one example, the server 500 may perform machine learning and/or data mining. The server 500 may perform learning using collected experience information. Based on the experience data, the server 500 may generate update information which will be described later on.

In another example, the mobile robot 100 may directly perform machine learning and/or data mining. The mobile robot 100 may perform learning using collected experience information. Based on the experience information, the mobile robot 100 may update an action control algorithm.

Referring to Td in FIG. 7, the mobile terminal 300a may be wireless-connected to the wireless router 400 via Wi-Fi or the like. Referring to Tc in FIG. 7, the mobile terminal 300a may be wireless-connected directly to the moving robot 100 via Bluetooth or the like. Referring to Tf in FIG. 7, the mobile terminal 300b may be wireless-connected directly to the server 500.

The network may further include a gateway (not shown). The gateway may relay communication between the moving robot 110 and the wireless router 400. The gateway may wirelessly communicate with the moving robot 100. The gateway may communicate with the wireless router 400. For example, communication between the gateway and the wireless router 400 may be based on Ethernet or Wi-Fi.

The term “learning” mentioned in this description may be implemented by deep learning. For example, the learning may be performed by reinforcement learning. The mobile robot 100 may obtain current state information through sensing of the sensing unit 130, perform an action according to the current state information, and obtain a reward according to the state information and the action, thereby performing the reinforcement learning. State information, action information, and reward information may form one experience information, and a plurality of experience information (state information action information-reward information) may be accumulatively stored by repeating such “state, action, and reward.” Based on the accumulatively stored experience information, an action to be performed by the mobile robot 100 in one state may be selected.

In one state, the mobile robot 100 may select optimal action information (exploitation action information or exploitation-action data) to obtain the best reward among the action information included in the accumulated experience information or may select new action information (exploration action information or exploration-action data) other than action information included in the accumulated experience information. The selection of the exploration action information may increase a possibility of obtaining a greater reward than the selection of the exploitation action information and allow a more variety of experience information to be accumulated, whereas the selection of the exploration action information has an opportunity cost of obtaining a smaller reward than the selection of the exploitation action information.

An action control algorithm is a predetermined algorithm that selects an action to be performed according to a sensing result in one state. Using the action control algorithm, a motion responsive to a current cleaning mode may be changed when the mobile robot 100 approaches the docking device 200.

In one example, the action control algorithm may include a predetermined algorithm for obstacle avoidance. Using the action control algorithm, the mobile robot 100 may control movement of the mobile robot 100 to avoid an obstacle when the obstacle is sensed. The mobile robot 100 may sense a position and a direction of the obstacle, and may control an action of the mobile robot 100 to move along a predetermined path using the action control algorithm.

In another example, the action control algorithm may include a predetermined algorithm for docking. In a docking mode, the mobile robot 100 may control an action of moving to the docking device 200 for docking using the action control algorithm. In the docking mode, the mobile robot 100 may sense a position and a direction of the docking device 200 and may control an action of the mobile robot 100 to move along a predetermined path using the action control algorithm.

Selection of an action of the mobile robot 100 in one state is performed by inputting the state information into the action control algorithm. The mobile robot 100 controls an action according to action information that is selected by inputting the current state information into the action control algorithm. The state information is an input value for the action control algorithm, and the action information is a result value obtained by inputting the state information into the action control algorithm.

The action control algorithm is preset before a learning step to be described later, and is provided to be changed (updated) through the learning step. The action control algorithm is preset in a product released state even before learning. Then, the mobile robot 100 generates a plurality of experience information, and the action control algorithm is updated through learning based on the plurality of experience information that is accumulatively stored.

Experience information is generated based on a result of controlling an action according to selected action information. As a result of performing one action P(An) by the action control algorithm in one state P(STn), another state P(STn+1) is reached and reward information Rn+1 corresponding to the another state P(STx) is obtained, and accordingly, one experience information is generated. Here, the generated experience information includes state information STn corresponding to the state P(STn), action information An corresponding to the action P(An), and the reward information Rn+1.

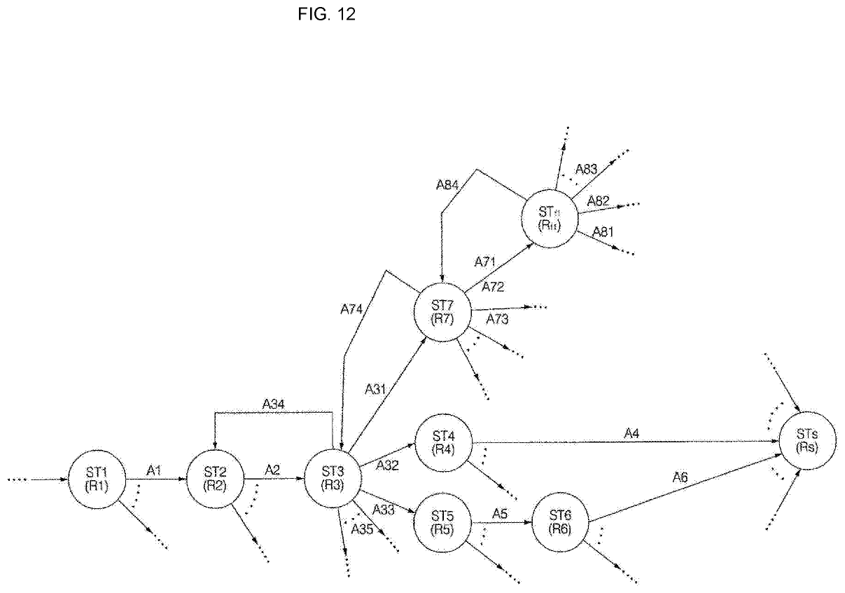

The experience information includes state information STx. Referring to FIGS. 12 to 20, one state information as data may be shown as STx, and an actual state of the mobile robot 100 corresponding to STx may be shown as P(STx). For example, the mobile robot obtains the state information STx through sensing of the sensing unit 130 in one state P(STx). Through the sensing of the sensing unit 130, the mobile robot 100 may intermittently obtain the latest state information. State information may be obtained at periodic intervals. In order to intermittently obtain such state information, the mobile robot 100 may intermittently perform sensing through the sensing unit 130 such as the image sensor.

According to a sensing method, the state information may include various types of information. The state information may include distance information. The state information may include obstacle information. The state information may include cliff information. The state information may include image information. The state information may include external signal information. The external signal information may include information on sensing of a guide signal such as an IR signal or an RF signal transmitted from the signal transmitter of the docking device 200.

The state information may include image information on at least one of the docking device and an environment around the docking device. The mobile robot 100 may recognize a shape, a direction, and a size of the docking device 200 through the image information. The mobile robot 100 may recognize an environment around the docking device 200 through the image information. The docking device 200 may include a marker that is disposed on an outer surface and thus remarkably discernable due to a difference in reflectivity, etc., and may recognize a direction and a distance of the marker through the image information.

The state information may include relative position information of the docking device 200 and the mobile robot 100. The relative position information may include information on a distance between the docking device 200 and the mobile robot 100. The relative position information may include direction information of the docking device 200 relative to the mobile robot 100.

The relative location information may be obtained through information on an environment around the docking device 200. For example, the mobile robot 100 may extract features extracted from the environment around the docking device 200 through image information to recognize relative positions of the mobile robot 100 and the docking device 200.

The state information may include information on an obstacle around the docking device 200. For example, based on the obstacle information, an action of the mobile robot 100 may be controlled to avoid an obstacle on a path along which that the mobile robot 100 moves to the docking device 200.

The experience information includes action information Ax that is selected by inputting the state information STx to the action control algorithm. Referring to FIGS. 12 to 20, one action information as data may be shown as Ax, and an actual action performed by the mobile robot 100 corresponding to Ax may be shown as P(Ax). For example, the mobile robot performs one action P(Ax) in one state P(STx), and one experience information is generated using the state information STx and the action information Ax together. One experience information includes one state information STx and one action information Ax.

Meanwhile, since there is a large number of action information Ax1, Ax2, . . . selectable for any one specific state information STx, different action information may be selected in the same state P(STx) depending on a case. However, when one action P(Ax) is performed in one state P(STx), only one experience information (including state information STx and action information Ax) may be generated.

The experience information further includes reward information Rx. The reward information Rx is information on a reward that is given when an action P(Ay) corresponding to one action information Ay is performed in a state P(STy) corresponding to one state information STy.

Reward information Rn+1 is a value received as a result of performing one action P(An) moving from one state P(STn) to another state P(STn+1). The reward information Rn+1 is a value that is set to correspond to the state P(STn+1) which is reached according to the action P(An). Since the reward information Rn+1 is a result of the action P(An), the reward information Rn+1 constitute one experience information together with previous state information STn and previous action information An. That is, the reward information Rn+1 is set to correspond to the state information STn+1, and generates one experience information together with the state information STn and the action information An. Each of the experience information includes reward information that is set based on a result of controlling an action according to action information belonging to corresponding experience information.

Reward information Rx may be a reward score Rx. The reward score Rx may be a scalar real value. Hereinafter, reward information will be described as a reward score.

The higher the reward score Rn+1 is received as a result of performing one action P(An) in one state P(STn), the more likely the action information An is to be used as exploitation action information in the state P(STn). That is, which of action information selectable for any one state information is optimal action information may be determined by determining which reward score is high or low. Here, the determination as to which reward score is high or low may be made based on a plurality of pre-stored experience information. For example, when a reward score Rx1 received as a result of performing one action P(Ay1) in one state P(STy) is higher than a reward score Rx2 received as a result of performing a different action P(Ay2) in the same state P(STy), it may be determined that the selection of the action information Ay1 in the state P(STy) is more advantageous than the selection of the action information Ay2 when it comes to successful docking.

A reward score Rx corresponding to any one specific state information P(STx) may be set as a sum of a value of the current state P(STx) and a probabilistic average value of a next state. For example, when one state P(STx) is a docking success state P(STs), the reward score Rx is composed of a value of the current state P(STs) alone, but when the state P(STx) is not the docking success state (P(STs), the reward score Rx may be calculated by summing up the value of the current state P(STs) and a probabilistic value(s) of a next step(s) that is probably selected from the current state P(STs). Details thereof may be technically implemented using well-known Markov Decision Process (MDF), or the like. Specifically, value repetition (VI), policy Iteration (PI), Monte Carlo method, Q-Learning, and State Action Reward State Action (SARSA) may be used.

As a result of performing an action according to the action information An, a reward score Rn+1 may be set relatively high when docking succeeds, and may be set relatively low when docking fails. A reward score Rs corresponding to a docking succeed state may be set as the highest among reward scores.

For example, if the state P(STn+1) is a state in which docking is more likely to succeed by a subsequent action(s), the higher the reward score Rn+1 corresponding to the state P(STn+1) is set relatively high.

Accordingly, when a state at a n+1th point in time is a docking complete state, an n+1th reward score to be described later may be set relatively high, and when the state at the n+1th point in time is a docking incomplete state, the n+1th reward score to be described later may be set relatively low.

The reward score (Rn+1) may be set in relation with at least one of the following: i) whether docking succeeds as a result of controlling an action according to the action information An, ii) a time required for docking, iii) the number of docking attempts until docking succeeds, and iv) whether obstacle avoidance succeeds.

For example, if the state P(STn+1) is a state in which docking is more likely to succeed relatively fast by a subsequent action(s), the reward score Rn+1 corresponding to the state P(STn+1) is set relatively high.

For example, if the state P(STn+1) is a state in which docking is more likely to succeed within a relatively short time by a subsequent action(s), the reward score Rn+1 corresponding to the state P(STn+1) is set relatively high.

For example, if the state P(STn+1) is a state in which it is more likely to succeed with a relatively small number of docking attempts by a subsequent action(s), the reward score Rn+1 corresponding to the state P(STn+1) is set relatively high.

For example, if the state P(STn+1) is a state in which an error is more likely to occur at a docking attempt by a subsequent action(s), the reward score Rn+1 corresponding to the state P(STn+1) is set relatively low.

For example, if the state P(STn+1) is a state in which obstacne avoidance is more likely to succeed by a subsequent action(s), the reward score Rn+1 corresponding to the state P(STn+1) is set relatively high. In addition, if the state P(STn+1) is a state in which collision with the docking device 200 and/or other obstacle is more likely to occur at a docking attempt by a subsequent action(s), the reward score Rn+1 corresponding to the state P(STn+1) is set relatively low.

Accordingly, based on a plurality of pre-stored experience information to which the n+1th state information belongs, if docking is more likely to succeed after the n+1th state, the n+1th reward score may be set high. In addition, based on a plurality of pre-stored experience information to which the n+1th state information belongs, if a probabilistically expected number of docking attempts until docking succeeds after the n+1th state is smaller, the n+1th reward score may be set high. In addition, if it is determined, based on a plurality of pre-stored experience information to which the n+1th state information belongs, that a probabilistically expected number of docking attempts until docking succeeds after the n+1th state is smaller, the n+1th reward score may be set high. Also, if it is determined, based on a plurality of pre-stored experience information to which the n+1th state information belongs, that a collision with an external obstacle is less likely to occur after the n+1th state, the n+1th reward score may be set high.

One example of setting a reward score is as follows. Referring to FIGS. 12 to 20, a reward score Rs corresponding to docking success state information STs may be set as 10 points, and a reward score Rf1 corresponding to one docking failure state information STf1 may be set as −10 points. For example, a reward score R7 corresponding to a state P(ST7) in which a docking success probability is relatively high when a subsequent action is performed may be set as 8.74 points. For example, a reward score R3 corresponding to a state P(ST3) in which it is more likely to take a relatively long time until a docking success when a subsequent action is performed may be set as 3.23 points.

The reward score may be changed or set based on accumulated experience information. Changing the reward score may be performed through learning. The changed score is reflected in an updated action control algorithm.

For example, an action selectable in one state P(STn+1) may be added or a reward score obtained as a result of performing an action in the state P(STn+1) may be changed, and accordingly, the reward score RN+1 corresponding to the state P(ST+1) may be changed. (Since a probabilistic average value of a next state is changed, an average value of the current state is changed as well.) If the reward score Rn+1 corresponding to the state P(STn+1) is changed, a reward score Rn corresponding to the state P(STn) before reaching P(STn+1) is changed as well.

The action control algorithm is set such that one of i) exploitation action information and ii) exploration action information is selected when one state information STr is input to the action control algorithm.

Here, the exploitation action information is action information which has the highest reward score among action information included in the experience information to which the state information STr belongs. Each experience information includes one state information, one action information, and one reward score, and it is possible to select action information (exploitation action information) having the highest reward score among (a plurality of) experience information having the state information STr. When the exploitation action information is selected, the acquisition of the state information STr is performed through matching with pre-stored state information.

Here, the exploration action information is action information other than action information included in the experience information to which the state information STr belongs. In one example, when new state information STr is generated and there is no experience information having the state information STr, the exploration action information may be selected. In another example, even if the state information STr is obtained through matching with pre-stored state information, new exploration action information may be selected instead of action information included in (a plurality of) experience information having the state information STr.

The action control algorithm is set such that one of the exploitation action information and the exploration action information is selected in some cases.

For example, the action control algorithm may be set such that any one of the exploitation action information and exploration action information is selected based on a probability. Specifically, when one state information STr is input to the action control algorithm, a probability of selecting the exploitation action information may be set to C1 % and a probability of selecting the exploration action information may be set to (100−C1)% (where C1 is a real value greater than 0 to less than 100).

Here, the value of C1 may be changed according to learning. In one example, as the cumulative amount of the experience information increases, the action control algorithm may be set to change such that a probability of selecting the exploitation action information from the exploitation action information and the exploration action information increases. In another example, as actional information of experience information having one state information is diversified, the action control algorithm may be changed to increase the probability of selecting the exploitation action information from the exploitation action information and the exploration action information.

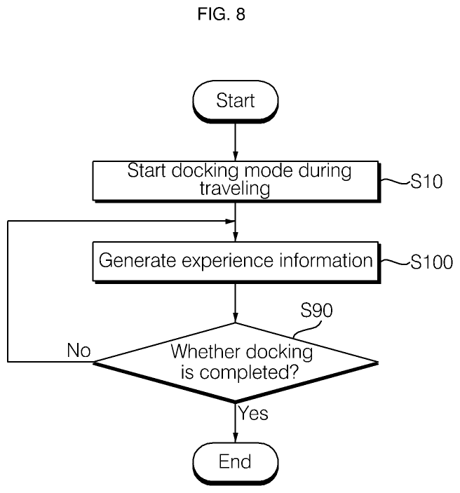

Hereinafter, a control method of a mobile robot and a control system of the mobile robot according to embodiments of the present disclosure will be described with reference to FIGS. 8 to 11. The control method may be performed only by the controller 140 according to an embodiment, or may be performed by the controller 140 and the server 500. The present disclosure may be a computer program for implementing each process of the control method or may be a storage medium which stores a program for implementing the control method. The “record medium” indicates a computer readable record medium. The present disclosure may be a control system including both hardware and software.

In some embodiments, functions for processes may be implemented in a sequence different from mentioned herein. For example, two consecutive processes may be performed at the same time or may be performed in an inverse sequence depending on a corresponding function.

Referring to FIG. 8, the control method of the mobile robot according to an embodiment of the present disclosure will be described as follows.

The mobile robot 100 may perform a predetermined task of the task unit 180 and may travel a travel area. When the task is completed or an amount of charged power of the battery 177 is equal to or less than a specific level, a docking mode may start in S10 while the mobile robot 100 is traveling.

The control method includes an experience information generating step S100 of generating experience information. In the step S100 of generating experience information, one experience information is generated. A plurality of experience information may be generated by repeatedly performing the experience information generating step S100. A plurality of experience information may be stored by repeatedly generating the experience information. In this embodiment, the experience information generating step S100 is performed after the docking mode starts in S10. Although not illustrated, the experience information generating step S100 may be performed regardless of the start of the docking mode.

The control method includes a process of determining whether docking is completed in S90. In the process S90, it may be determined whether current state information STx is the docking success state information STs. If the docking is not completed, the experience information generating step S100 may continue. The experience information generating step S100 may be performed until docking is completed.

P mentioned in the following description is a natural number equal to or greater than 2, and the state at a p+1th point in time is a docking complete state. In addition, am n+1th point in time is a point in time after an nth point in time. The n+1th point in time is a point in time which is reached as a result of the mobile robot 100 performing an action according to action information selected at the nth point in time.

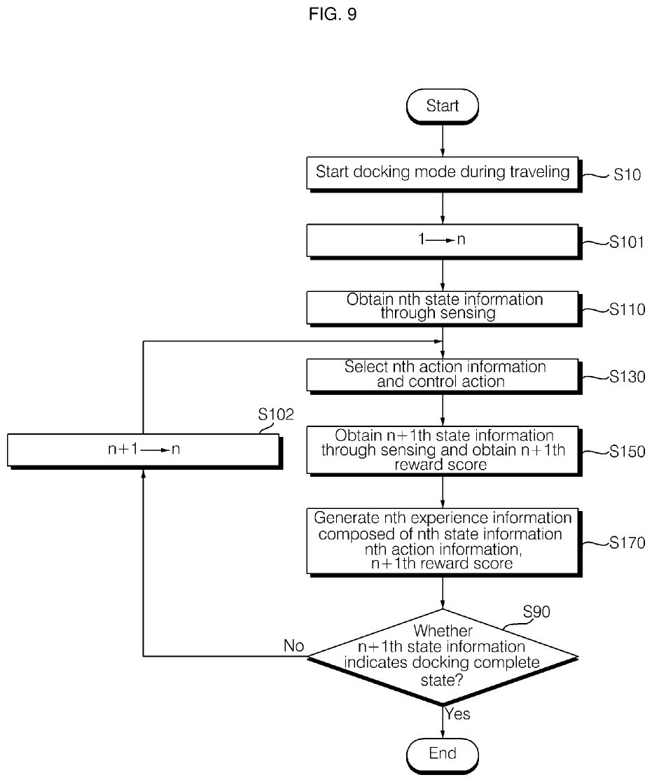

Referring to FIG. 9, in the experience information generating step, current state information is obtained through sensing during traveling in steps S110 and S150. In the experience information generating step, n-th state information is obtained through sensing in a state at the n-th point in time during traveling in steps S110 and S150. Here, n is an arbitrary natural number equal to or greater than 1 or equal to or less than p+1.

Through the above-described steps S110 and S150, each state information is obtained from a first point in time to the p+1th point in time. That is, the first to p+1th state information is obtained through the above-described steps S110 and S150.

Through the step S110, the first state information is obtained through sensing in the state at the first point in time. That is, after the docking mode starts in step S10, the first state information is obtained in step S110.

Through the step S150, the second to p+1th state information is obtained through sensing in the states at the second point in time to the p+1th point in time. That is, by repeatedly performing the steps S102 S130, S150, and S170 until docking is completed, (a plurality of) state information may be obtained through sensing in a state(s) after an initial state.

Among the obtained first to p+1th state information, the first to pth state information constitutes part of the first to pth experience information, respectively. In addition, among the obtained first to p+1th state information, the p+1th state information is a basis for determining whether docking is completed in step S90.

Referring to FIG. 9, in the experience information generating step, an action is controlled according to action information that is selected by inputting current state information to the predetermined action control algorithm in step S130. In the experience information generating step, n-th state information is input to the action control algorithm to control the action according to the n-th action information selected (S130). Here, n is an arbitrary natural number equal to or greater than 1 or equal to or less than p.

Through the step S130, first to pth action information is input to the action control algorithm to select first to pth state information, respectively. Through the step S130, the first to pth action information is sequentially selected. The obtained first to pth action information constitutes part of first to pth experience information, respectively.

Referring to FIG. 9, in the experience information generating step, a reward score is obtained based on a result of controlling an action according to action information in step S150. In the experience information generating step, an n+1th reward score is obtained based on a result of controlling an action according to the n-th action information in step S150. Here, n is an arbitrary natural number equal to or greater than 1 or equal to or less than p.

An n+1th reward score is set to correspond to n+1th state information that is obtained through sensing in a state at the n+1th point in time. Specifically, through the step S150, the n+1th state information may be obtained as a result of controlling an action of the mobile robot 100 according to the nth action information, and the n+1th reward score corresponding to the n+1th state information may be obtained.

Through the step S150, second to p+1th state information is obtained as a result of controlling an action of the mobile robot 100 according to the first to pth action information, and second to p+1th reward scores respectively corresponding to the second to p+1th is obtained. Through the above-described step S150, second to p+1th reward scores are sequentially obtained. The obtained second to p+1th reward scores constitutes part of the first to pth experience information, respectively.

Referring to FIG. 9, in the experience information generating step, each experience information is generated in step S170. In the experience information generating step, nth experience information is generated in step S170. Here, n is an arbitrary natural number equal to or greater than 1 or equal to or less than p.

In the step S170 of generating each experience information, one experience information including the state information and the action information is generated. The one experience information further includes a reward score that is set based on a result of controlling an action according to the action information belonging to the corresponding experience information.

In the step S170 of generating nth experience information, the nth experience information including nth state information and nth action information is generated. The nth experience information further includes an n+1th reward score set based on a result of controlling an action according to the nth action information. That is, the nth experience information may include the nth state information, the nth experience information, and the n+1th reward score.

Referring to FIG. 9, the overall process of generating experience information will be described in a chronological order, as follows. Here, n is initially set to 1 in step S101, and is sequentially increased by 1 until n becomes p in step S102. First, a docking mode starts while the mobile robot 100 is traveling in step S10. At this time, n is set to 1 in step S101. Then, a step S110 of obtaining first state information through sensing is performed. Then, the first state information is input to the action control algorithm to select the first action information and control an action of the mobile robot 100 accordingly in step S130. Then, second state information is obtained through sensing, and a second reward score corresponding to the second state information is obtained in step S150. Accordingly, the first experience information including the first state information, the first action information, and the second reward score are generated in step S170. At this time, it is determined in step S90 whether the second state information indicates a docking complete state, and if the second state information indicates the docking complete state, the experience information generating step ends, and if the second state information does not indicate the docking complete state, n is set to be increased by 1 in step S102 and then the process is proceeded with from the step S130. At this time, n becomes 2.

Referring to FIG. 9, the step S130 to be performed again by generalizing to n is as follows. Here, the following description is based on a point in time after n is increased by 1 according to the above-described step S102. After the step S102, nth action information is selected in step S130 by inputting the nth state information, which is obtained in the step S150 before the step S102, to the action control algorithm. (Here, the nth state information input to the action control algorithm refers to the n+1th state information at the time of acquisition, but the nth state information is named based on a point in time after n is increased by 1 through the step S102.) After the action of the mobile robot 100 according to the nth action information in step S130, n+1th state information is obtained through sensing and an n+1th reward score corresponding to the n+1th state information is obtained in step S150. Accordingly, first experience information composed of the nth state information, the nth action information, and the nth reward score is generated in step S170. At this time, it is determined whether the n+1th state information indicates the docking complete state in step S90, and if the n+1th state information indicates the docking complete state, the experience information generating step ends, and if the n+1th state information does not indicate the docking complete state, n is set to be increase by 1 in step S102 and the process is proceeded with from the step S130.

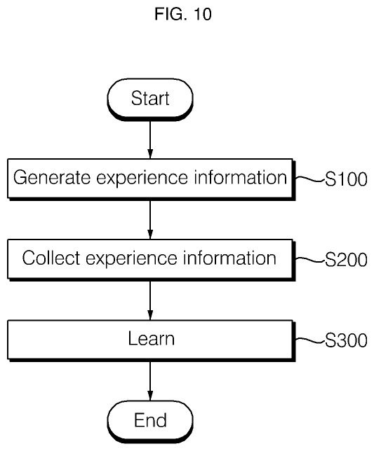

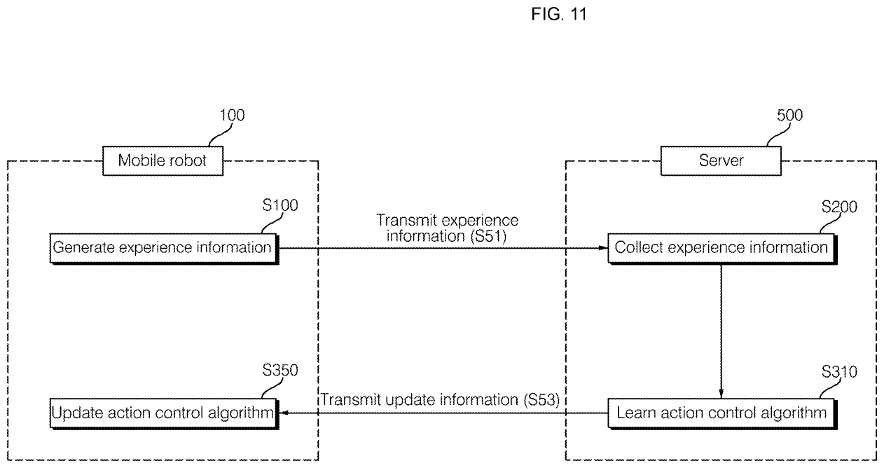

Referring to FIGS. 10 and 11, the control method includes an experience information collecting step S200 of collecting generated experience information. A plurality of experience information is stored in step S200 by repeatedly performing the experience information generating step. First to pth experience information is stored in step S200 by repeatedly performing the experience information generating step in an order from the case where n is 1 to the case where n is p.

Referring to FIGS. 10 and 11, the control method includes a learning step S300 of learning the action control algorithm based on the plurality of stored experience information. In the learning step S300, the action control algorithm is learned based on the first to pth experience information. In the learning step S300, the action control algorithm may be learned using the reinforcement learning method described above. In the learning step S300, it is possible to find a change element of the action control algorithm. In the learning step S300, the action control algorithm may be updated immediately, or update information for updating the action control algorithm may be generated.

In the learning step S300, a state reached according to action information selected based on each state information may be analyzed to change a reward score corresponding to corresponding state information. For example, based on a large number of experience information, to which one state information STx belongs, and (a plurality of) action information selectable based on corresponding state information ST, it is possible to determine i) a statistical probability of a docking success, ii) a statistical time required for a docking success, iii) the number of docking attempts until docking succeeds, and/or iv) a statistical probability of an obstacle avoidance success, and a reward score corresponding to state information STx may be reset accordingly. The detailed description about the case where the reward score is high or low is as described above.

In one embodiment, the experience information collecting step S200 and the learning step S300 are performed by the controller 140 of the mobile robot 100. In this case, the plurality of generated experience information may be stored a storage 179. The controller 140 may learn the action control algorithm based on a plurality of experience information stored in the storage 179.

Referring to FIG. 11, in another embodiment, the mobile robot 100 performs the experience information generating step S100. Then, the mobile robot 100 transmits the generated experience information to the server 500 over a predetermined network in step S51. The step S51 of transmitting experience information may be performed immediately after each experience information is generated, or may be performed after a predetermined amount or more of experience information is temporarily stored in the storage 179 of the mobile robot 100. The step S51 of transmitting experience information may be performed after the docking complete state of the mobile robot 100. The server 500 performs an experience information collection step S200 by receiving the experience information. Then, the server 500 performs the learning step S300. The server 500 learns an action control algorithm based on a plurality of collected experience information in step S310. In the step S310, the server 500 generates update information for updating the action control algorithm. Then, the server 500 transmits the update information to the mobile robot 100 over the network in step S53. Then, the mobile robot 100 updates a pre-stored action control algorithm based on the received update information in step S350.

In one example, the update information may include an updated action control algorithm. The update information may be an updated action control algorithm (program) itself. In the learning step S310 performed by the server 500, the server 500 updates the action control algorithm stored in the server 500 using the collected experience information, and the action algorithm updated in the server 500 at this time may be the update information. In this case, the mobile robot 100 may perform the update by replacing the updated action control algorithm received from the server 500 with the pre-stored action control algorithm of the mobile robot 100 in step S350.

In another example, the update information may be information that causes an existing action control algorithm to be updated, not the action control algorithm itself. In the learning step S310 performed by the server 500, the server 500 may drive a learning engine using the collected experience information to generate the update information. In this case, the mobile robot 100 may perform the update in the step S350 by changing the pre-stored action control algorithm of the mobile robot 100 based on the update information received from the server 500.

In another embodiment, experience information generated by each of a plurality of mobile robots 100 may be transmitted to the server 500. The server 500 may learn the action control algorithm based on a plurality of experience information received from the plurality of mobile robots 100 in step S310.

In one example, based on the experience information collected from the plurality of mobile robots 100, an action control algorithm to be collectively applied to the plurality of mobile robots 100 may be learned.

In another example, it is also possible to learn each action control algorithm for each mobile robot 100 based on experience information collected from the plurality of mobile robots 100. In a first example, the server 500 classifies the experience information received from the plurality of mobile robots 100, and sets only experience information received from a particular mobile robot 100 as a basis for learning an action control algorithm for the particular mobile robot 100. In a second example, the experience information collected from the plurality of mobile robots 100 may be classified into a common learning-based group and an individual learning-based group according to a predetermined criterion. In the second example, experience information included in the common learning-based group may be set to be used for learning of the action control algorithms for all the plurality of mobile robots 100, and experience information included in the individual learning-based group may be set to be used for learning of each mobile robot 100 that has generated the corresponding experience information.

Hereinafter, a process of generating experience information according to one scenario of the control method will be described with reference to FIGS. 12 to 20. FIGS. 12 to 20, there are illustrated examples of a situation that is likely to take place while a mobile robot 100 moves to a docking device 200 using an action control algorithm after the docking mode starts.

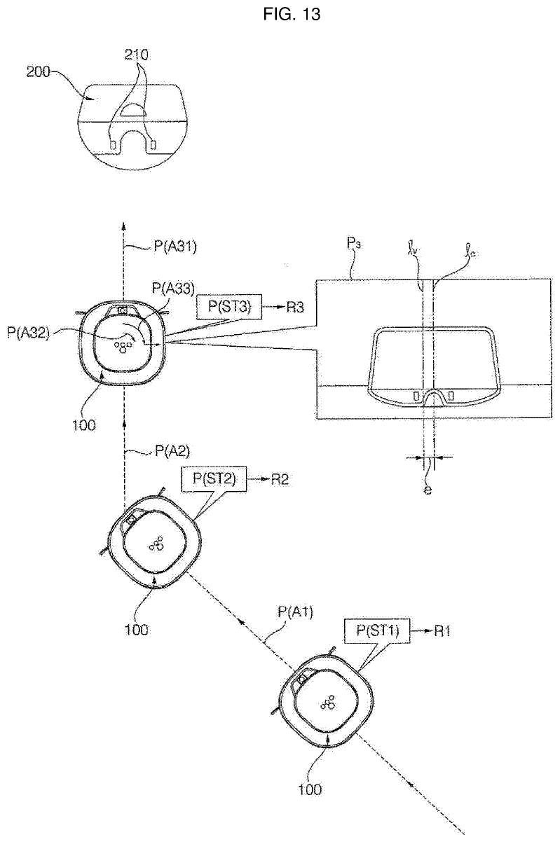

Referring to FIGS. 12 and 13, the mobile robot 100 reaches a state P(ST1) after performing an action for a certain period of time since the start of the docking mode. In the state P(ST1), the mobile robot 100 obtains state information ST1 through sensing. Further, the mobile robot 100 obtains a reward score R1 corresponding to the state information ST1. The reward score R1 is used, together with state information and action information corresponding to a state prior to the state ST1 and an previous action, to generate one experience information.

In this scenario, the mobile robot 100 selects action information A1 from among a variety of action information A1, . . . that can be selected in the state P(ST1) by the action control algorithm. Referring to FIG. 13, an action P(A1) according to the action information A1 is traveling straight forward to a position of the state P(ST2).

As a result of the action P(A1), the mobile robot 100 reaches a state P(ST2) after performing the action P(A1). In the state P(ST2), the mobile robot 100 obtains state information ST2 through sensing. Further, the mobile robot 100 obtains a reward score R2 corresponding to the state information ST2. The reward score R2 is used together with previous state information ST1 and previous action information A1 to generate one experience information.

In this scenario, the mobile robot 100 selects action information A2 from among a variety of action information A2, . . . that can be selected in the state P(ST2) by the action control algorithm. Referring to FIG. 13, an action P(A2) according to the action information A2 is rotating to the right until facing the docking device 200 and then traveling a predetermined distance straight forward

As a result of the action P(A2), the mobile robot 100 reaches a state P(ST3) after performing the action P(A2). Referring to FIG. 13, in the state P(ST3), the mobile robot 100 obtains the state information ST3 through sensing of image information P3. In the image information P3, it can be seen that a virtual central vertical line Iv of an image of the docking device 200 is shifted to the right by the value e from a virtual central vertical line Iv of an image frame. The state information ST3 includes information which reflects the level of e by which the docking device 200 is shifted to the right, as viewed from the front of the mobile robot 100.

The mobile robot 100 obtains a reward score R3 corresponding to the state information ST3. The reward score R3 is used as the previous state information ST2 and the previous action information A2 to generate one experience information.

Referring to FIGS. 12 and 13, the mobile robot 100 may select any one of various action information A31, A32, A33, A34, . . . that can be selected in the state P(ST3) by the action control algorithm. For example, an action P(A31) according to the action information A31 is traveling a predetermined distance straight forward. For example, an action P(A32) according to the action information A32 is rotating by a predetermined acute angle to the right by taking into consideration the level of e by which the docking device 200 is shifted to the right from the front of the mobile robot 100. For example, the action P(A33) according to the action information A33 is traveling a predetermined distance straight forward in consideration of the level of e by which the docking device 200 is shifted to the right from the front of the mobile robot 100 after the mobile robot rotates to the right by 90 degrees.

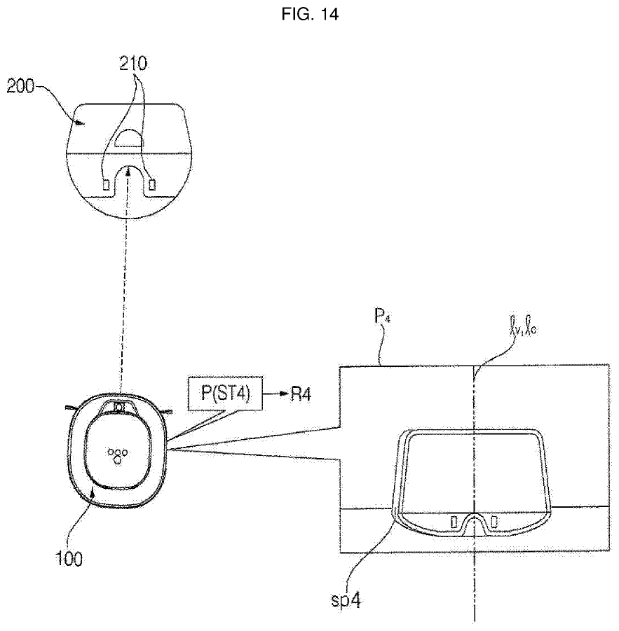

Referring to FIGS. 12 and 14, it is assumed that the mobile robot 100 performs the action P(A32) in the state P(ST3). As a result of the action P(A32), the mobile robot 100 reaches the state P(ST4) after performing the action P(A32). In the state P(ST4), the mobile robot 100 obtains state information ST4 through sensing of image information P4. In the image information P4, a virtual central vertical line lv of an image of the docking device 200 coincides with a virtual central vertical line lv of an image frame, but a part of an image of a left side sp4 of the docking device 200 is seen. Since the mobile robot 100 faces the front side of the docking device while located at a position slightly apart from the front side of the docking device 200, the above-described image information P4 is sensed. The state information ST4 includes information reflecting that the mobile robot 100 faces the front side of the docking device 200 while located at a position spaced a predetermined value apart to the left from the front side of the docking device 200.

The mobile robot 100 obtains a reward score R4 corresponding to the state information ST4. The reward score R4 is used together with the previous state information ST3 and the previous action information A32 to generate one experience information.

In this scenario, the mobile robot 100 selects action information A4 from among a variety of action information A4, . . . that can be selected in the state P(ST4) by the action control algorithm. Referring to FIG. 14, an action P(A4) according to the action information A4 is traveling straight forward in a direction to the docking device 200.

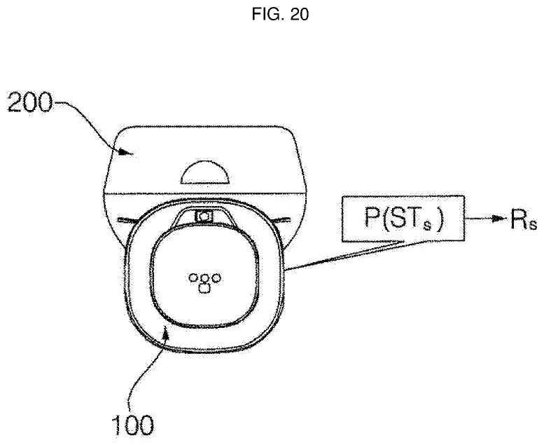

In this scenario, referring to FIGS. 12 and 20, as a result of the action P(A4), the mobile robot 100 reaches a docking success state P(STs) after performing the action P(A4). For example, in the docking success state P(STs), the mobile robot 100 obtains the docking success state information STs through the docking sensor. At this time, the mobile robot 100 obtains a reward score Rs corresponding to the state information STs. The reward score Rs is used together with the previous state information ST4 and the previous action information A4 to generate one experience information.

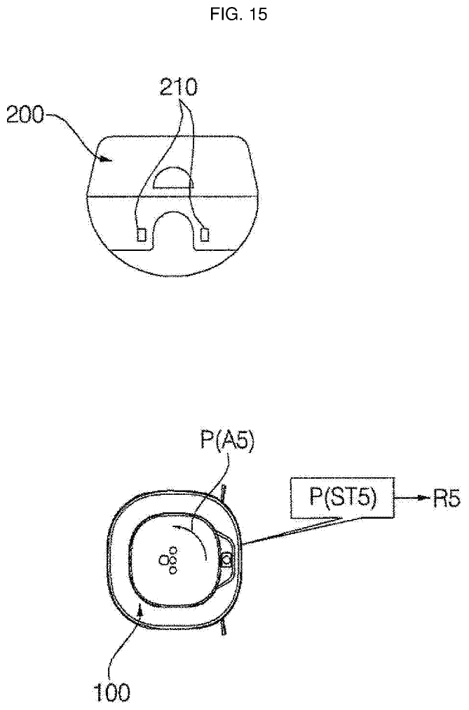

Meanwhile, referring to FIGS. 12 and 15, it is assumed that the mobile robot 100 performs the action P(A33) in the state P(ST3). As a result of the action P(A33), the mobile robot 100 reaches the state P(ST5) after performing the action P(A33). In the state P(ST5), the mobile robot 100 obtains state information ST5 through sensing.

The mobile robot 100 obtains a reward score R5 corresponding to the state information ST5. The reward score R5 is used together with the previous state information ST3 and the previous action information A33 to generate one experience information.

In this scenario, the mobile robot 100 selects action information A5 from among a variety of action information A5, . . . that can be selected in the state P(ST5) by the action control algorithm. Referring to FIG. 15, an action P(A5) according to the action information A5 is rotating by 90 degrees to the left.

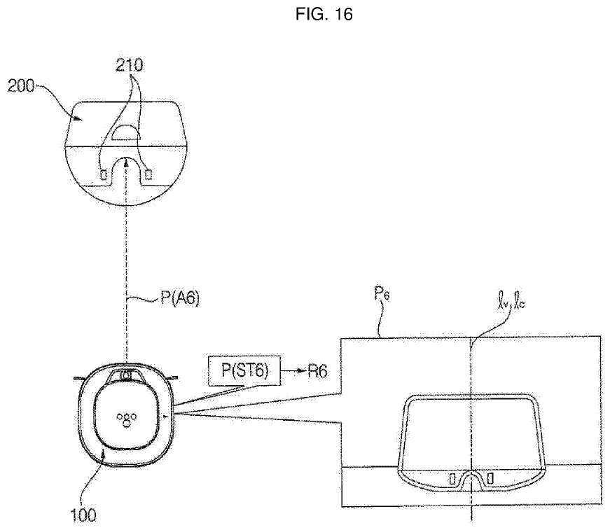

Referring to FIGS. 12 and 16, as a result of the action P(A5), the mobile robot 100 reaches a state P(ST6) after performing the action P(A5). In the state P(ST6), the mobile robot 100 obtains state information ST6 through sensing of image information P6. In the image information P6, it can be seen that a virtual central vertical line Iv of an image of the docking device 200 coincides with a virtual central vertical line Iv of an image frame. The state information ST6 includes information reflecting that the docking device 200 is placed right in front of the mobile robot 100.

The mobile robot 100 obtains a reward score R6 corresponding to the state information ST6. The reward score R6 is used together with the previous state information ST5 and the previous action information A5 to generate one experience information.

In this scenario, the mobile robot 100 selects action information A6 from among a variety of action information A6, . . . that can be selected in the state P(ST6) by the action control algorithm. Referring to FIG. 14, an action P(A6) according to the action information A6 is traveling straight forward in a direction to the docking device 200.

In this scenario, referring to FIGS. 12 and 20, as a result of the action P(A6), the mobile robot 100 reaches the docking success state P(STs) after performing the action P(A6). For example, in the docking success state P(STs), the mobile robot 100 obtains the docking success state information STs through the docking sensor. At this time, the mobile robot 100 obtains a reward score Rs corresponding to the state information STs. The reward score Rs is used together with the previous state information ST6 and the previous action information A6 to generate one experience information.

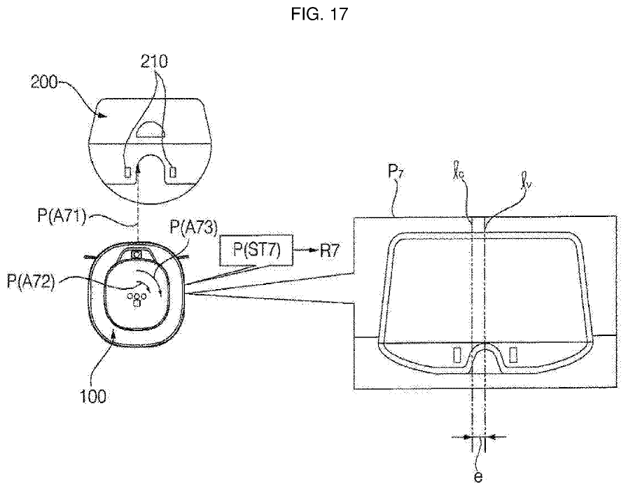

Meanwhile, referring to FIGS. 12 and 17, it is assumed that the mobile robot 100 performs the action P(A31) in the state P(ST3). As a result of the action P(A31), the mobile robot 100 reaches the state P(ST7) after performing the action P(A31). In the state P(ST7), the mobile robot 100 obtains the state information ST7 through sensing of image information P7. In the image information P7, it can be seen that a virtual central vertical line lv of an image of the docking device 200 is shifted to the right from a virtual central vertical line lv of an image frame by a value e, and that the image of the docking device 200 is relatively enlarged. Since the mobile robot 100 is closer to the docking device 200 in the state P(ST7) than in the state P(ST3), the above-described image information P7 is sensed. The state information (ST7) includes information reflecting that the mobile robot 100 faces the front side of the docking device 200 while located at a position spaced apart a predetermined value to the left from the front side of the docking device 200, and information reflecting that the mobile robot 100 is close to the docking device by a predetermined level or more.

The mobile robot 100 obtains a reward score R7 corresponding to the state information ST7. The reward score R7 is used together with the previous state information ST3 and the previous action information A31 to generate one experience information.

In this scenario, the mobile robot 100 receives action information A71 from among a variety of action information A71, A72, A73, A74, . . . that can be selected in the state P(ST7) by the action control algorithm. Referring to FIG. 17, for example, an action P(A71) according to the action information A71 is traveling straight forward in a direction to the docking device 200. For example, an action P(A72) according to the action information A72 is rotating by a predetermined acute angle to the right in consideration of the level of e by which the docking device 200 is shifted to the right from the front side of the mobile robot 100. For example, an action P(A73) according to the action information A73 is rotating 90 degrees to the right. For example, an action P(A74) according to the action information A74 is traveling backward.

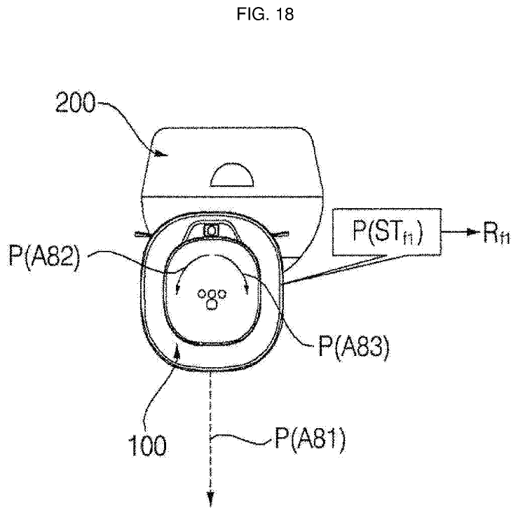

In this scenario, referring to FIGS. 12 and 18, as a result of the action P(A71), the mobile robot 100 reaches the docking failure state P(STf1) after performing the action P(A71). For example, in the docking failure state P(STf1), the mobile robot 100 obtains docking failure state information STf1 through sensing by the docking sensor, the impact sensor, and/or the gyro sensor. At this time, the mobile robot 100 obtains a reward score Rf1 corresponding to the state information STf1. The reward score Rf1 is used together with the previous state information ST7 and the previous action information A71 to generate one experience information.

Meanwhile, there are various docking failure states P(STf1), P(STf2), . . . that can occur according to actions in different cases. Docking failure state information STf1, STf2, . . . may be obtained through sensing in each of the docking failure states P(STf1), P(STf2), . . . . Reward scores Rf1, Rf1, . . . corresponding to the respective docking failure state information STf1, STf2, . . . are obtained. The respective reward scores Rf1, Rf1, . . . may be set differently.

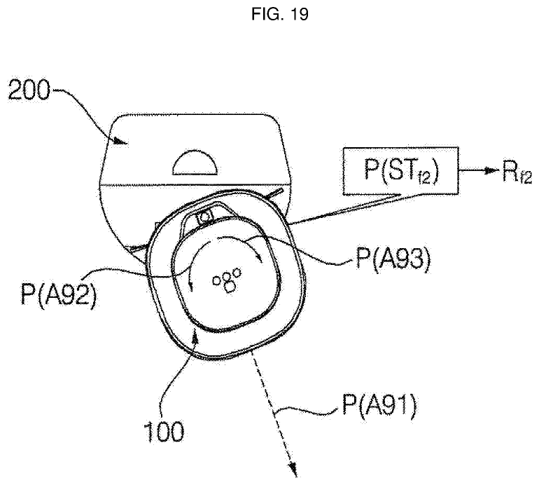

FIG. 18 shows the docking failure state P(STf1) in one case, and FIG. 19 shows the docking failure state P(STf2) in another case.

Referring to FIG. 19, as a result of performing any one action in one state, the mobile robot 100 reaches the docking failure state P(STf2). For example, in the docking failure state P(STf2), the mobile robot 100 obtains the docking failure state information STf2 through sensing by the docking sensor, the impact sensor, and/or a gyro sensor. At this time, the mobile robot 100 obtains a reward score Rf2 corresponding to the state information STf2. The reward score Rf2 is used together with previous state information and previous action information to generate one experience information.

The action information according to the above-described scenario are merely examples, and there may be various other action information. For example, even if the same straight movement or backward movement information, a wide variety of action information may exist according to a difference in a moving distance. For another example, even for the same rotating movement, a variety of action information may be provided according to a difference in angles of rotation, a difference in radius of rotation, and the like.

Although it has been exemplarily illustrated that state information is obtained using image information having an image of the docking device in the above scenario, it is also possible to obtain state information based on image information having an image of an environment around the docking device. In addition, the state information may be obtained through sensing information of various sensors other than the image sensor 138, and the state information may be obtained through a combination of two or more sensing information of two or more sensors.

[explanation of reference marks]

| | |
|---|---|
| 100: mobile robot | 110: main body |
| 111: case | 112: dust container |
| | cover |
| 130: sensing unit | 131: distance sensor |
| 132: cliff sensor | 138: image sensor |
| 138a: front image | 138b: upper image |
| sensor | sensor |
| 138c: lower image | 139: pattern emission |
| sensor | unit |
| 139a: first pattern | 139b: second pattern |
| emission unit | emission unit |
| 138a, 139a, 139b: | 140: controller |
| 3D sensor | |
| 160: The traveler | 166: drive wheel |
| 168: auxiliary wheel | 171: input unit |
| 173: output unit | 175: communication |
| | unit |
| 177: battery | 179: The storage |
| 180: task unit | 180h: suction port |
| 184: brush | 185: auxiliary brush |
| 190: corresponding | 200: docking device |
| terminal | |
| 210: charging terminal | 300a, 300b: mobile |
| | terminal |
| 400: wireless router | 500: server |
| STx: state information | P(STx): state |
| Ax: action information | P(Ax): action |
| Rx: reward information, | |
| reward score | |

1. A mobile robot, comprising:
a main body;
a traveler configured to move the main body;
a sensing unit configured to perform sensing during traveling to obtain current state information; and
a controller configured to, based on a result of controlling an action according to action information selected by inputting the current state information to a predetermined action control algorithm for docking, generate one experience information including the state information and the action information, repeatedly perform the generating of the experience information to store a plurality of experience information, and learn the action control algorithm based on the plurality of experience information.

2. A control method of a mobile robot, the method comprising:
an experience information generating step of obtaining current state information through sensing during traveling, and, based on a result of controlling an action according to action information selected by inputting the current state information to a predetermined action control algorithm for docking, generating one experience information that comprises the state information and the action information;
an experience information collecting step of storing a plurality of experience information by repeatedly performing the experience information generating step; and
a learning step of learning the action control algorithm based on the plurality of experience information.

3. The control method of claim 2, wherein each of the plurality of experience information further comprises a reward score that is set based on a result of controlling an action according to action information belonging to corresponding experience information.

4. The control method of claim 3, wherein the reward score is set relatively high when docking succeeds as a result of performing the action according to the action information, and the reward score is set relatively low when docking fails when as a result of performing the action according to the action information.

5. The control method of claim 3, wherein the reward score is set in relation to at least one of: i) whether docking succeeds as a result of performing the action according to the action information, ii) a time required for docking, iii) a number of docking attempts until docking succeeds, and iv) whether obstacle avoidance succeeds.

6. The control method of claim 3, wherein the action control algorithm is set to select at least one of the following when one state information is input to the action control algorithm: i) exploitation action information to obtain a highest reward score among action information included in the experience information to which the one state information belongs, and ii) exploration action information other than action information included in the experience information to which the one state information belongs.

7. The control method of claim 2, wherein the action control algorithm is preset before the learning step and able to be changed through the learning step.

8. The control method of claim 2, wherein the state information comprises relative position information of the docking device and the mobile robot.

9. The control method of claim 8, wherein the state information comprises image information on at least one of the docking device and an environment around the docking device.

10. The control method of claim 2,
wherein the mobile robot is configured to transmit the experience information to a server over a predetermined network, and
wherein the server is configured to perform the learning step.

11. A control method of a mobile robot, the method comprising:
an experience information generating step of obtaining n^{th} state information through sensing in a state at an n^{th} point in time during traveling, and, based on a result of controlling an action according to nth action information selected by inputting the nth state information to a predetermined action control algorithm for docking, generating nth experience information that comprises the nth state information and the nth action information;
an experience information collecting step of storing first to p^{th} experience information by repeatedly performing the experience information generating step in ab order from a case where n is 1 to a case where n is p; and
a learning step of learning the action control algorithm based on the first to p^{th} experience information,
wherein p is a natural number equal to or greater than 2, and a state at a p+1^{th} point in time is a docking complete state.

12. The control method of claim 11, wherein the nth experience information further comprises an n+1^{th} reward score that is set based on a result of controlling an action according to the nth action information.

13. The control method of claim 12, wherein, in the experience information generating step, the n+1^{th} reward score is set in response to n+1^{th} state information obtained through sensing in a state at an n+1^{th} point in time.

14. The control method of claim 13, wherein the n+1^{th} reward score is set relatively high when the state at the n+1th point in time is a docking complete state, and the n+1th reward score is set relatively low when the state at the n+1th point in time is a docking incomplete state.

15. The control method of claim 13, wherein, based on a plurality of pre-stored experience information to which the n+1th state information belongs, the n+1th reward score may be set to increase i) as a probability of a docking success after the n+1th state increases, ii) as a probabilistically expected time required until docking succeeds after the n+1th state decreases, or iii) as a probabilistically expected number of docking attempts until docking succeeds after the n+1th state decrease.

16. The control method of claim 13, wherein the n+1th reward score is set, based on a plurality of pre-stored experience information to which the n+1th state information belongs, to increase as a probability of a collision with an external obstacle after the n+1th state decreases.

17. A control method of a mobile robot, the method comprising:
an experience information generating step of obtaining n^{th} state information through sensing in a state at an n^{th} point in time during traveling, based on a result of controlling an action according to n^{th} action information selected by inputting the n^{th} state information to a predetermined action control algorithm for docking, obtaining n+1^{th} reward score, and generating n^{th} experience information that comprises the n^{th} state information, the n^{th} action information, and the n+1^{th} reward score;
an experience information collecting step of storing first to p^{th} experience information by repeatedly performing the experience information generating step in ab order from a case where n is 1 to a case where n is p; and
a learning step of learning the action control algorithm based on the first to p^{th} experience information,
wherein p is a natural number equal to or greater than 2, and a state at a p+1^{th} point in time is a docking complete state.
